(19) United States
(12) Patent Application Publication
(10) Pub. No.: US 2016/0004983 A1
(43) Pub. Date: Jan. 7, 2016

(54) METHOD AND APPARATUS FOR QUANTIFYING DIMENSIONAL VARIATIONS AND PROCESS CAPABILITY INDEPENDENTLY OF DATUM POINTS

(71) Applicant: GM Global Technology Operations LLC, Detroit, MI (US)

(72) Inventor: Hua-Tzu Fan, Troy, MI (US)

(73) Assignee: GM Global Technology Operations LLC, Detroit, MI (US)

(21) Appl. No.: 14/753,307

(22) Filed: Jun. 29, 2015

Related U.S. Application Data
(60) Provisional application No. 62/021,582, filed on Jul. 7, 2014.

(51) Int. Cl. G06Q 10/06; G05B 19/418

(52) U.S. Cl. CPC G06Q 10/06; G05B 19/41875

(57) ABSTRACT

A measurement system receives design values specifying measurement points of a first design and values corresponding to measurement points of a first part manufactured according to the first design using a first process. The system calculates a reference point of the first part and translates the received values based on a difference between reference points of the first part the first design. The system includes a rotation module that applies a rotational transformation with a first angle to the translated values. The system includes an error minimization module that determines a first value for the first angle that minimizes deviations between the transformed values and the specified design values. The system includes an error determination module that computes deviations between the transformed values and the specified design values. The system includes an analysis module that calculates a process metric of the first process based on the computed deviations.

### CROSS-REFERENCE TO RELATED APPLICATIONS

This application claims the benefit of U.S. Provisional Application No. 62/021,582, filed on Jul. 7, 2014. The entire disclosure of the application referenced above is incorporated herein by reference.

### FIELD

The present disclosure relates to determining dimensional variations of manufactured parts and more particularly to quantifying dimensional variations and process capability independently of datum points.

### BACKGROUND

When parts, such as vehicle components, are designed, manufacturing tolerances may be assigned to various dimensions and features of the designed parts. In preparation for manufacturing a part in volume, one or more trial runs of the part may be manufactured. The manufactured test parts are measured to determine how closely they match the defined specifications for the designed part. These comparisons can be used to calculate the manufacturing process capability, and determine whether changes need to be made to the part or to the process to improve the manufacturing process capability.

For example only, FIG. 1A shows a simple triangular part design having reference points A₀, B₀, and P₀. The triangle may correspond to a thin, planar triangle or may represent a face or cross-section of a part. Acceptable tolerances may be defined in magnitude and direction for points A₀, B₀, and P₀.

In FIG. 1B, an exemplary manufactured part according to the design of FIG. 1A is shown. The reference points on the manufactured part are labeled as Aₘ, Bₘ, and Pₘ. The manufactured part of FIG. 1B may be measured by, for example, a coordinate measurement machine or manually using a fixture and gage. When placing the manufactured part in the fixture, or into a holding mechanism for the coordinate measurement machine, the manufactured part is aligned based on a selected feature of the manufactured part.

For example, in FIG. 2A, the manufactured part is oriented in the fixture so that point Aₘ is in a zero position that corresponds to the design point A₀. From there, the difference between design point B₀ and manufactured part point Bₘ can be seen. In addition, the difference between design point P₀ and manufactured part point Pₘ can be seen and is labeled with error arrow e₁.

In FIG. 2B, a different datum point is used to fix the manufactured part. In this case, manufactured part point Bₘ is fixed to a zero point in the fixture to correspond to design point B₀. The error (labeled e₂) between design point P₀ and manufactured part point Pₘ has changed in both magnitude and direction with respect to FIG. 2A. In addition, there is now no measured error in manufactured part point Bₘ, but a measured error has appeared in design point Aₘ. As can be seen from this simple example, selection of datum point can change the measured error for the design points. This may create uncertainty and error when determining process capability for a part and make it difficult to determine which points of a part are creating manufacturing problems.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method includes receiving a plurality of values corresponding to measurement points of a first part manufactured according to a first design using a first manufacturing process. The first design specifies design values for the measurement points. The method further includes calculating a reference point of the first part based on the received values. The method further includes translating the received values based on a difference between the reference point of the first part and a reference point of the first design. The method further includes applying a rotational transformation to the translated values to produce transformed values. The rotational transformation includes a first angle. The method further includes determining a first value for the first angle that minimizes deviations between the transformed values and the specified design values. The method further includes computing deviations between (i) the transformed values corresponding to the first value and (ii) the specified design values. The method further includes calculating a process metric of the first manufacturing process based on the computed deviations for the first part and computed deviations for a plurality of additional parts. The method further includes, based on the process metric, selectively performing at least one of (i) adjusting the first manufacturing process and (ii) selecting a different process for manufacturing the first design.

In other features, the process metric is one of a process capability and a process capability index. In other features, the plurality of values for each point of the measurement points includes a set of coordinates. The translating the received values includes determining translation coordinates by subtracting coordinates of the reference point of the first design from coordinates of the reference point of the first part and, for each point of the measurement points, generating the translated values by subtracting the translation coordinates from the set of coordinates for the point.

In other features, the plurality of values for each point of the measurement points includes a set of coordinates. The coordinates for the reference point of the first design are zero. The translating the received values includes, for each point of the measurement points, generating the translated values by subtracting coordinates of the reference point of the first part from the set of coordinates for the point. The applying the rotational transformation rotates the translated values about a zero point.

In other features, the reference point of the first design is a centroid of the first design. The reference point of the first part is a centroid of the first part. In other features, the method further includes calculating the reference point of the first design, wherein the reference point of the first design is a centroid of the first design. In other features, the determining the first value includes minimizing an error metric based on a sum of a square of each individual deviation between each of the transformed values and the respective specified design values. In other features, the method further includes measuring the values corresponding to the measurement points of the first part.

In other features, the method further includes manufacturing the first part using the first manufacturing process. In other features, the process metric of the first manufacturing process is calculated based on the computed deviations for the first part and computed deviations for a plurality of additional parts. In other features, the method further includes comparing the first manufacturing process to a second manufacturing process based on the process metric and a process metric of the second manufacturing process. In other features, the method further includes determining a plurality of process metrics, including the process metric, wherein each of the plurality of process metrics corresponds to a respective one of the measurement points of the first design.

In other features, the method further includes, in response to the process metric, at least one of (i) modifying the first design and (ii) modifying tolerances of one or more of the measurement points of the first design. In other features, the rotational transformation includes a second angle and a third angle. The rotational transformation includes rotating by the first angle about a z-axis of a first coordinate system of the first part, resulting in a second coordinate system; rotating by the second about a x-axis of the second coordinate system, resulting in a third coordinate system; and rotating by the third angle about a z-axis of the third coordinate system.

A non-transitory computer-readable medium stores instructions executable on a processor, and the instructions are configured to perform receiving a plurality of values corresponding to measurement points of a first part manufactured according to a first design using a first manufacturing process. The first design specifies design values for the measurement points. The instructions are further configured to perform calculating a reference point of the first part based on the received values. The instructions are further configured to perform translating the received values based on a difference between the reference point of the first part and a reference point of the first design. The instructions are further configured to perform applying a rotational transformation to the translated values to produce transformed values. The rotational transformation includes a first angle. The instructions are further configured to perform determining a first value for the first angle that minimizes deviations between the transformed values and the specified design values. The instructions are further configured to perform computing deviations between (i) the transformed values corresponding to the first value and (ii) the specified design values. The instructions are further configured to perform calculating a process metric of the first manufacturing process based on the computed deviations for the first part and computed deviations for a plurality of additional parts. The instructions are further configured to perform, based on the process metric, selectively performing at least one of (i) adjusting the first manufacturing process and (ii) selecting a different process for manufacturing the first design.

In other features, the process metric is one of a process capability and a process capability index. In other features, the plurality of values for each point of the measurement points includes a set of coordinates. The translating the received values includes determining translation coordinates by subtracting coordinates of the reference point of the first design from coordinates of the reference point of the first part and, for each point of the measurement points, generating the translated values by subtracting the translation coordinates from the set of coordinates for the point.

In other features, the plurality of values for each point of the measurement points includes a set of coordinates. The coordinates for the reference point of the first design are zero. The translating the received values includes, for each point of the measurement points, generating the translated values by subtracting coordinates of the reference point of the first part from the set of coordinates for the point. The applying the rotational transformation rotates the translated values about a zero point.

In other features, the reference point of the first design is a centroid of the first design. The reference point of the first part is a centroid of the first part. In other features, the instructions are further configured to perform calculating the reference point of the first design, wherein the reference point of the first design is a centroid of the first design. In other features, the determining the first value includes minimizing an error metric based on a sum of a square of each individual deviation between each of the transformed values and the respective specified design values. In other features, the instructions are further configured to perform measuring the values corresponding to the measurement points of the first part.

In other features, the instructions are further configured to perform manufacturing the first part using the first manufacturing process. In other features, the process metric of the first manufacturing process is calculated based on the computed deviations for the first part and computed deviations for a plurality of additional parts. In other features, the instructions are further configured to perform comparing the first manufacturing process to a second manufacturing process based on the process metric and a process metric of the second manufacturing process. In other features, the instructions are further configured to perform determining a plurality of process metrics, including the process metric, wherein each of the plurality of process metrics corresponds to a respective one of the measurement points of the first design.

In other features, the instructions are further configured to perform, in response to the process metric, at least one of (i) modifying the first design and (ii) modifying tolerances of one or more of the measurement points of the first design. In other features, the rotational transformation includes a second angle and a third angle. The rotational transformation includes rotating by the first angle about a z-axis of a first coordinate system of the first part, resulting in a second coordinate system; rotating by the second about a x-axis of the second coordinate system, resulting in a third coordinate system; and rotating by the third angle about a z-axis of the third coordinate system.

A measurement system receives design values specifying measurement points of a first design and values corresponding to measurement points of a first part manufactured according to the first design using a first process. The system calculates a reference point of the first part and translates the received values based on a difference between reference points of the first part the first design. The system includes a rotation module that applies a rotational transformation with a first angle to the translated values. The system includes an error minimization module that determines a first value for the first angle that minimizes deviations between the transformed values and the specified design values. The system includes an error determination module that computes deviations between the transformed values and the specified design values. The system includes an analysis module that calculates a process metric of the first process based on the computed deviations.

In other features, the process metric is one of a process capability and a process capability index. In other features, the reference point of the first design is a centroid of the first design. The reference point of the first part is a centroid of the first part. Coordinates for the reference point of the first design are zero. The plurality of values for each point of the measurement points includes a set of coordinates. Translating the received values includes, for each point of the measurement points, generating the translated values by subtracting coordinates of the reference point of the first part from the set of coordinates for the point. The applying the rotational transformation rotates the translated values about a zero point.

In other features, the design input module is configured to calculate the reference point of the first design and translate the specified design values of the first design to locate the reference point of the first design at a zero point of a coordinate system. In other features, the determining the first value includes minimizing an error metric based on a sum of a square of each individual deviation between each of the transformed values and the respective specified design values.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1A is a top view of an example part design according to the prior art.

FIG. 1B is a top view of an example manufactured part according to the prior art.

FIG. 2A is a top view of a comparison between designed and manufactured parts according to the prior art.

FIG. 2B is a top view of a second comparison between the designed and manufactured parts according to the prior art.

FIG. 3A is a top view of an example part design.

FIG. 3B is a top view of an example manufactured part.

FIG. 4A is a top view of a translation of the manufactured part.

FIG. 4B is a top view of a rotation of the manufactured part following the translation.

FIG. 5 is a high-level hardware diagram of an example computing device according to the present disclosure.

FIG. 6 is a functional block diagram of an example measurement system.

FIG. 7A is a flowchart demonstrating example operation of a design and manufacturing process.

FIG. 7B is a flowchart demonstrating example operation of a measurement transformation process.

FIG. 8 is a top view of an example part identifying measurement points.

FIGS. 9A-9B together are a chart of measurement deviations and statistical parameters for each measurement point for a set of example parts.

FIGS. 10A-10B together are a chart of transformed measurement deviations and resulting statistical parameters for the set of parts.

FIG. 11A is a plot of measurement deviations for each measurement point for the set of parts.

FIG. 11B is a plot of transformed measurement deviations for the set of parts.

In the drawings, reference numbers may be reused to identify similar and/or identical elements.

### DETAILED DESCRIPTION

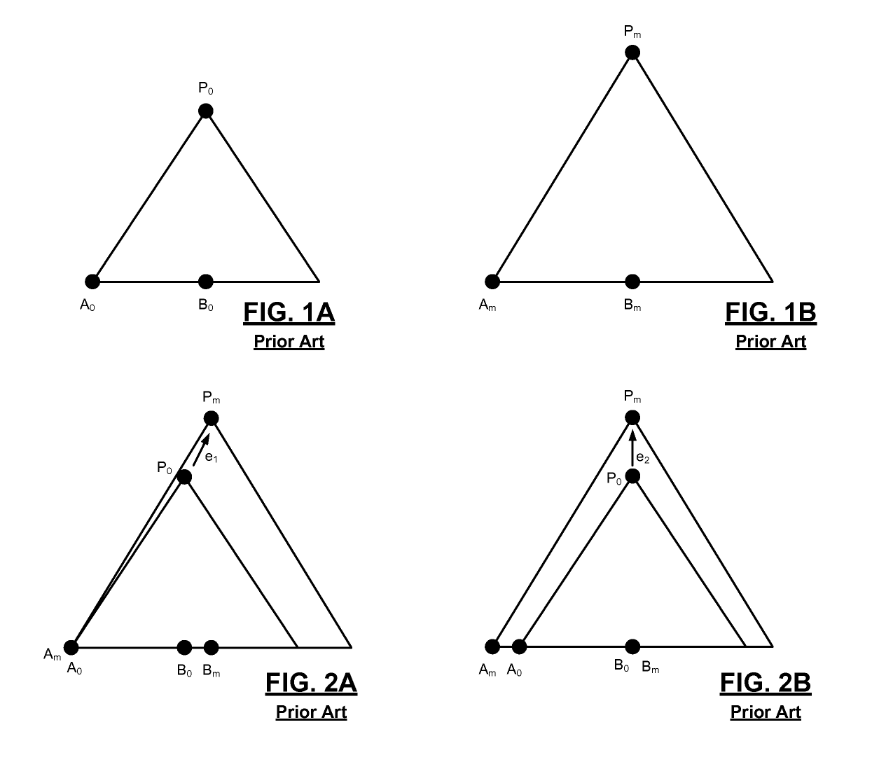

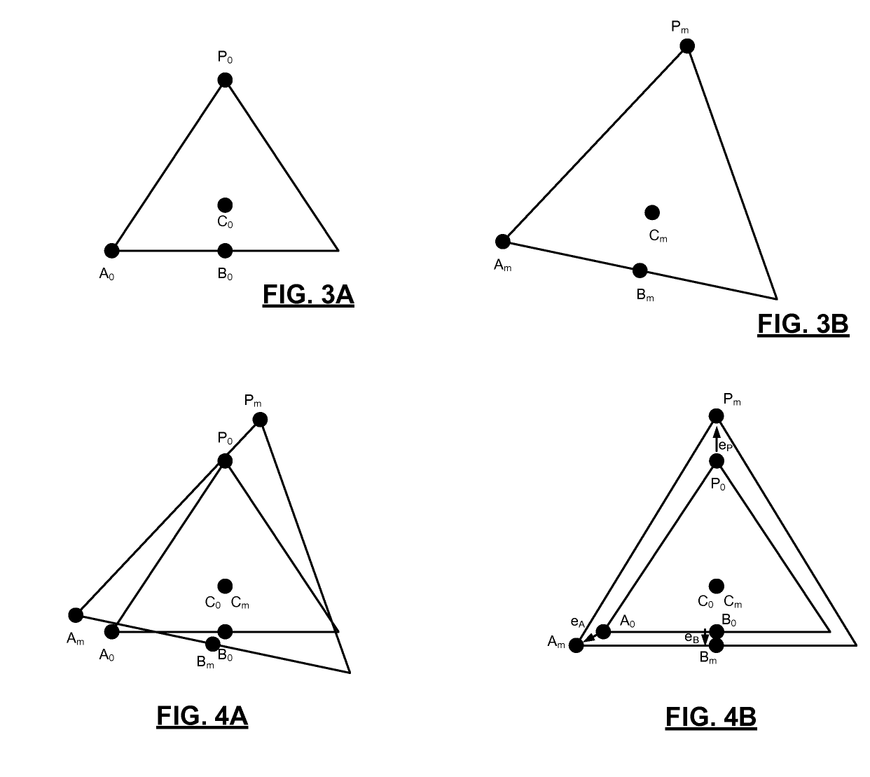

In FIG. 3A, a design for a simple triangular part, similar to that of FIG. 1A, is shown. Design points A₀, B₀, and P₀ are defined for the designed part. In FIG. 3B, measurements of a manufactured part according to the design of FIG. 3A are shown. The measurements may be collected using a coordinate measurement machine or by using a probe that is positioned manually by an operator. The measurement points are Aₘ, Bₘ, and Pₘ.

Note that the manufactured part appears to be rotated in comparison with the designed part. Rotation may be created depending on how the part is attached to the measurement fixture. For example, buildup of debris on the fixture itself or on the part may cause the part to sit at an angle on the fixture. Generally, the rotation will be less pronounced than is shown, so FIG. 3B has been exaggerated for purposes of illustration.

According to the present disclosure, the measurement points of the manufactured part are translated and then rotated to minimize the error between the measurement points and the design dimensions. This eliminates, or at least mitigates, the datum dependency demonstrated by FIGS. 2A and 2B. The manufacturing deviations calculated based on this transformation allow the process to be more accurately assessed, such as by more accurately calculating a process capability. This transformation also establishes a consistent mechanism for comparing manufactured parts and processes without dependence on such variables as (i) the datum points selected for alignment and (ii) offsets created at the interface between a manufactured part and a measurement fixture.

Specifically, various implementations of the present disclosure include determining a calculated point of the manufactured part: point Cₘ in FIG. 3B. The measurement points of the manufactured part are then translated so that calculated point Cₘ of the manufactured part has the same coordinates as calculated point C₀ of the designed part. The calculated points may be center points of the manufactured part and designed part, respectively. In various implementations, a center point may be defined as a centroid in either two or three dimensions.

In FIG. 4A, the manufactured part is shown having been translated so that the calculated point Cₘ of the manufactured part is aligned with the calculated point C₀ of the designed part. As described in more detail below, the manufactured part is then rotated, as shown in FIG. 4B, to minimize the overall error between the measured points and the design points.

To determine the desired angles of rotation, a rotational transformation is applied to the measured points of the manufactured part. This transformation is applied symbolically so that the angle or angles of the transformation can be solved for. The transformed measurement points of the manufactured part are then compared to the design points to determine deviations as a function of rotation angles. The angles are chosen to minimize an error metric, which may be, for example, a sum of absolute values of the deviations or the sum of the square of each of the deviations.

Once the rotational transformation is determined that minimizes the error metric of interest is applied, the resulting deviations between the part and the design can be determined. These deviations can be used to determine whether the part itself meets or fails the design criteria, and can be used with other transformed measurements to determine accuracy of the process. Accuracy may be expressed in terms of a process capability.

More formally, given a 3-dimensional part A that has n measurement points, E={\vec{e₁}, \vec{e₂}, . . . , \vec{eₙ}} is a set of deviations at each of the n measurement points. For three dimensions, \vec{e₁} is a 1×3 error vector representing the deviation in each dimension of measurement point i. Deviation set E can be represented by a n×3 matrix:

$$E = [ \begin{matrix}{e}_{1 x} & {e}_{1 y} & {e}_{1 z} \\ {e}_{2 x} & {e}_{2 y} & {e}_{2 z} \\ ⋮ & ⋮ & ⋮ \\ {e}_{nx} & {e}_{ny} & {e}_{nz}\end{matrix} ]$$

where eᵢₓ, e_{iy}, and e_{iz} are the x, y, and z components of \vec{eᵢ}.

Another matrix, P₀, is defined to represent the nominal dimensions of the designed part (designed dimensions):

$${P}_{0} = [ \begin{matrix}{p}_{01 x} & {p}_{01 y} & {p}_{01 z} \\ {p}_{02 x} & {p}_{02 y} & {p}_{02 z} \\ ⋮ & ⋮ & ⋮ \\ {p}_{0 nx} & {p}_{0 ny} & {p}_{0 nz}\end{matrix} ]$$

where p₀ᵢₓ, p_{0iy}, and p_{0iz} are the x, y, and z coordinates of the ith dimension of the designed part.

Let Pₘ represent the measured dimensions of the manufactured part:

$${P}_{m} = [ \begin{matrix}{p}_{m 1 x} & {p}_{m 1 y} & {p}_{m 1 z} \\ {p}_{m 2 x} & {p}_{m 2 y} & {p}_{m 2 z} \\ ⋮ & ⋮ & ⋮ \\ {p}_{mnx} & {p}_{mny} & {p}_{mnz}\end{matrix} ]$$

where pₘᵢₓ, p_{miy}, and P_{miz} are the x, y, and z coordinates of the ith dimension of the manufactured part.

By definition, the deviation E is:

E=Pₘ−P₀

Let the geometry centroid of the nominal part be c₀ and the centroid of the manufactured part be cₘ. The amount of translation d is calculated as:

d=cₘ−c₀=[dₓ,d_{y},d_{z}]

where cₘ, c₀, and d are each a 1×3 vector.

The manufactured part's coordinates P′₀ after translation are:

$${P}_{0}^{′} = {P}_{0} + [ \begin{matrix}1 \\ 1 \\ ⋮ \\ 1\end{matrix} ] d$$

where P′₀ is an n×3 matrix.

For a part with geometrically symmetric measurement points, the centroid may be simply calculated as the center (average) of all measurement points:

$${d}_{x} = \frac{1}{n} {\sum }_{i = 1}^{n} ( {p}_{mix} - {p}_{0 ix} )$$

$${d}_{y} = \frac{1}{n} {\sum }_{i = 1}^{n} ( {p}_{miy} - {p}_{0 iy} )$$

$${d}_{z} = \frac{1}{n} {\sum }_{i = 1}^{n} ( {p}_{miz} - {p}_{0 iz} )$$

According to Euler's rotation theorem, any 3-dimensional rotation can be described using three angles. A common notation for a set of 3 Euler angles is: (i) first, rotate by an angle φ about the z-axis; (ii) second, rotate by an angle θε[0, π] about the new x-axis (x′); and (iii) third, rotate by an angle ψ about the new z-axis (z′).

The general rotation matrix A can then be expressed according to three elementary rotation matrices B, C, and D as:

$$A = BCD = [ \begin{matrix}cos ψ & sin ψ & 0 \\ - sin ψ & cos ψ & 0 \\ 0 & 0 & 1\end{matrix} ] [ \begin{matrix}1 & 0 & 0 \\ 0 & cos θ & sin θ \\ 0 & - sin θ & cos θ\end{matrix} ] [ \begin{matrix}cos φ & sin φ & 0 \\ - sin φ & cos φ & 0 \\ 0 & 0 & 1\end{matrix} ] = [ \begin{matrix}cos ψ cos φ - cos θ sin φ sin ψ & cos ψ sin φ + cos θ cos φ sin ψ & sin ψ sin θ \\ - sin ψ cos φ - cos θ sin φ cos ψ & - sin ψsin φ + cos θ cos φ cos ψ & cos ψ sin θ \\ sin θ sin φ & - sin θ cos φ & cos θ\end{matrix} ]$$

The nominal part's coordinate after translation and rotation is then:

P″₀=P″₀A^{T}

where P″₀ is an n×3 matrix.

The set of Euler angles that minimizes total deviations (sum of squares of deviations) between the nominal and manufactured parts can then be determined. The optimization problem can be expressed as follows:

$$\{ \begin{matrix}{min}_{φ , θ , ψ} \vert {E}^{″} \vert \\ {E}^{″} = {P}_{m} - {P}_{0}^{″} \\ {P}_{0}^{″} = {P}_{0}^{′} {A}^{T} \\ {P}_{0}^{′} = {P}_{0} + [ \begin{matrix}1 \\ 1 \\ ⋮ \\ 1\end{matrix} ] d\end{matrix}$$

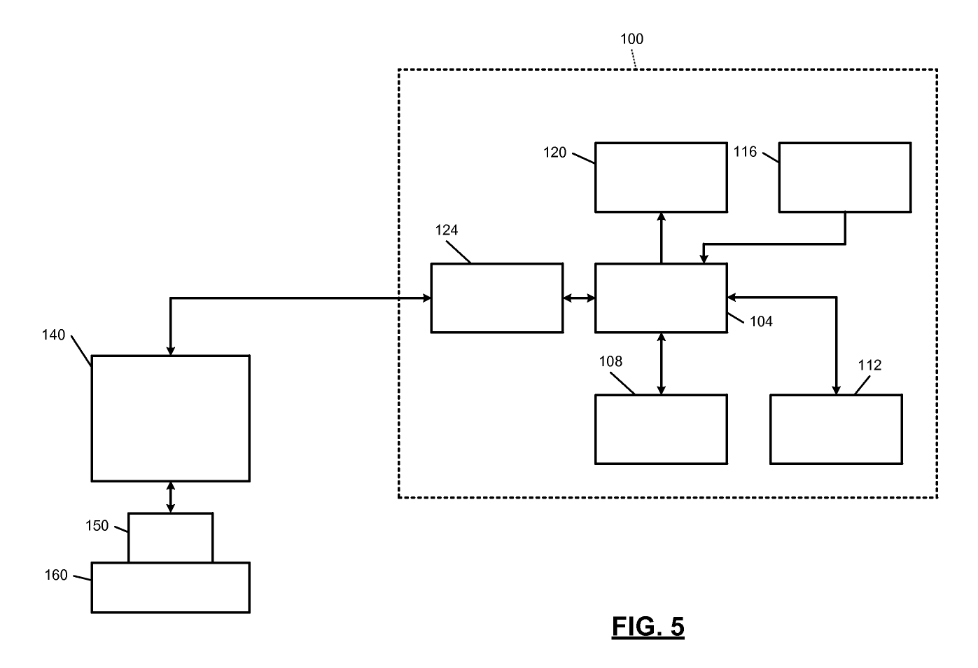

In FIG. 5, simplified hardware of an example implementation of a computing device 100 is shown. In various implementations, the computing device 100 is, or is part of, an apparatus that performs the methods described in the present disclosure.

A processor 104 executes instructions from a memory 108, and may operate on (read and/or write) data stored in the memory 108. Generally, the memory 108 includes volatile memory, such as dynamic random access memory. The processor 104 communicates, potentially via a chipset (not shown), with nonvolatile storage 112, which may include flash memory acting as a cache of instructions and/or data.

In various implementations, larger capacity and lower cost storage may also be included in the nonvolatile storage 112. For example, optical drives, tape drives, or magnetic storage media, such as hard drives, may be used to store data in the nonvolatile storage 112. Active portions of the data and/or instructions may be cached in the memory 108 and/or in portions of the nonvolatile storage 112 (which may include flash memory).

Input devices 116 receive user input, and may include devices such as a keyboard, a mouse, a touchpad, a digitizer tablet, etc. A display 120 displays data to the user, and in various implementations, may be combined with a touch sensitive input device in the form of a touchscreen. A communications interface 124 allows the computing device 100 to communicate with other computing devices—for example, over a local area network or a wide area network, such as the Internet. The local area network may include a wired network or a wireless network.

The computing device 100 may interface with a remote computing device (not shown) via the communications interface 124. Some processing may be offloaded from the processor 104 to the remote computing device. The remote computing device may be placed in a location where additional heat and noise can be generated without disturbing the user. The location may also satisfy other conditions, such as ready access to electrical power, the presence of backup power systems and fire suppression systems, and regulated environmental conditions, including temperature and/or humidity.

The remote computing device may therefore perform tasks that would take significant amounts of time when executed on the processor 104. These tasks may be accelerated by the remote computing device, and the computing device 100 may be returned to use for other functions by the user while the remote computing device is performing processing. The remote computing device may service multiple users, and may interact with other remote computing devices (not shown) to load balance processing requests.

For simplicity of illustration, many well-known components, buses, and devices of common computing devices are omitted. For example only, audio inputs and outputs are not shown, graphics cards and accelerators are not shown, and technologies such as direct memory access (DMA) between the memory 108 and the nonvolatile storage 112 are not illustrated.

The computing device 100 may also interface with a physical dimension measurement apparatus 140. The communications interface 124 may interface with the physical dimension measurement apparatus 140 over a local area network. Alternatively, the physical dimension measurement apparatus 140 may interface with the computing device 100 using a different open or proprietary protocol, such as RS232.

In various implementations, data from the physical dimension measurement apparatus 140 may be provided to the computing device 100 using other mechanisms, such as manual data entry. This would be more likely when the physical dimension measurement apparatus 140 is manually-controlled as opposed to computer-controlled.

The physical dimension measurement apparatus 140 measures specific points on a manufactured part 150 that is supported by a fixture 160. The fixture 160 may secure the part 150 in place, such as by using a clamp. In some implementations, gravity acting on the part 150 may be sufficient to create friction that prevents movement of the part 150 with respect to the fixture 160. Certain points on flat surfaces, such as point Bₘ of FIG. 3B, may be identified by the physical dimension measurement apparatus 140 based on features added to the designed part for this purpose. For example, a dimple or protrusion may be formed at point Bₘ to allow its location to be determined by the physical dimension measurement apparatus 140. In other examples, a visual indicator, such as an etched or pointed crosshairs, may be used as a reference.

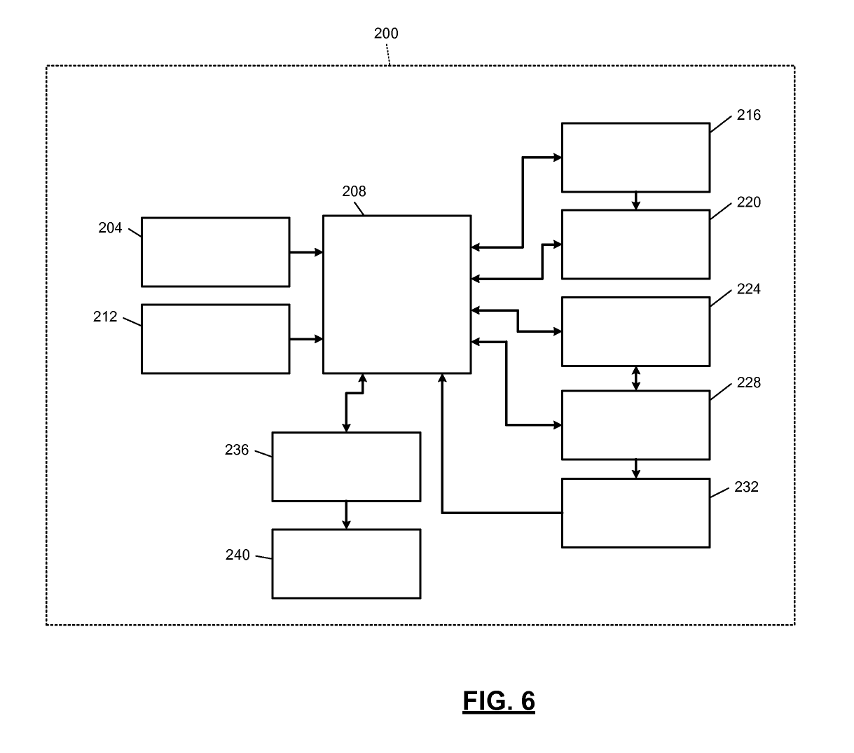

In FIG. 6, a functional block diagram of an example measurement system 200, which may be implemented by the computing device 100, is shown. A design input module 204 receives data regarding a designed part. This data is stored in a storage module 208, and may be parsed and transformed by the design input module 204 for use by the measurement system 200.

The design data may be received from a CAD (computer-aided design) user interface and/or from a CAD file that was output by a supported CAD or CAE (computer-aided engineering) program. In various implementations, the measurement system 200 may be integrated with a CAD or CAE program—for example, as a plugin or module.

A measurement input module 212 receives data about one or more manufactured parts. This data may come from the physical dimension measurement apparatus 140 either directly via a network or indirectly via manual entry or another mechanism such as a computer readable barcode printed by the physical dimension measurement apparatus 140 and applied to the part. Measurements of manufactured parts may be parsed into an internal storage format and stored in the storage module 208.

A centroid determination module 216 determines a calculated point of each part. In this example, the calculated point is a centroid. The centroid determination module 216 may also calculate a centroid for the designed part, or this information may be received with the other design data through the design input module 204.

A translation module 220 translates the measured points to align the centroid of the manufactured part with the centroid of the designed part. For example only, the design data may have been normalized to its centroid prior to storage in the storage module 208 so that the centroid of the designed part is at the zero point of the coordinate system and the coordinates of each point of the designed part are defined by their distance from the centroid. As a result, the manufactured part can be aligned with the designed part simply by subtracting the coordinates of the centroid of the manufactured part from each of the measured points of the manufactured part. The translated measurement points are stored in the storage module 208.

An error minimization module 224 determines a set of angles that minimize the errors between the translated and rotated measurement points and the design points. When the part is treated as a two-dimensional part, the set of angles may include a single angle, or the other angles in the set may be forced to zero. For a three-dimensional part, the set of angles may include two or three angles. The determined set of angles from the rotation module 228 may be stored in the storage module 208 to avoid having to recalculate those angles if the process is repeated for a given measured part.

A rotation module 228 applies the determined rotational transformation to the measured points and provides the transformed points to an error determination module 232. The error determination module determines the deviations (which have been minimized in the aggregate) between the manufactured part and the designed part. These determined deviations are stored in the storage module 208.

The storage module 208 therefore stores error data for each manufactured part. The storage module 208 may store metadata about those errors, including identification of the design iteration corresponding to that part, identification of the physical part itself, and an identification of the process iteration used to generate that part.

Further metadata may include a time at which the part was manufactured and a time at which the dimensions of the part were measured. When multiple physical dimension measurement apparatuses are used, the metadata may reflect which apparatus was used and, when an operator is involved, the metadata may specify an identity of the operator, such as by name or employee number.

An analysis module 236 analyzes the error data for a set of parts generated by a certain iteration of a manufacturing process. From this analysis, a process capability can be determined. Other analysis can include statistical calculations of error for each design point, and may express the error in terms of absolute distance or as a percentage of distance with respect to the distance between the design point and the design centroid. In addition, the storage module 208 may store the error of each design point as a vector and not just a scalar number. Variances, arithmetic means, and standard deviations may then be calculated using vector mathematics.

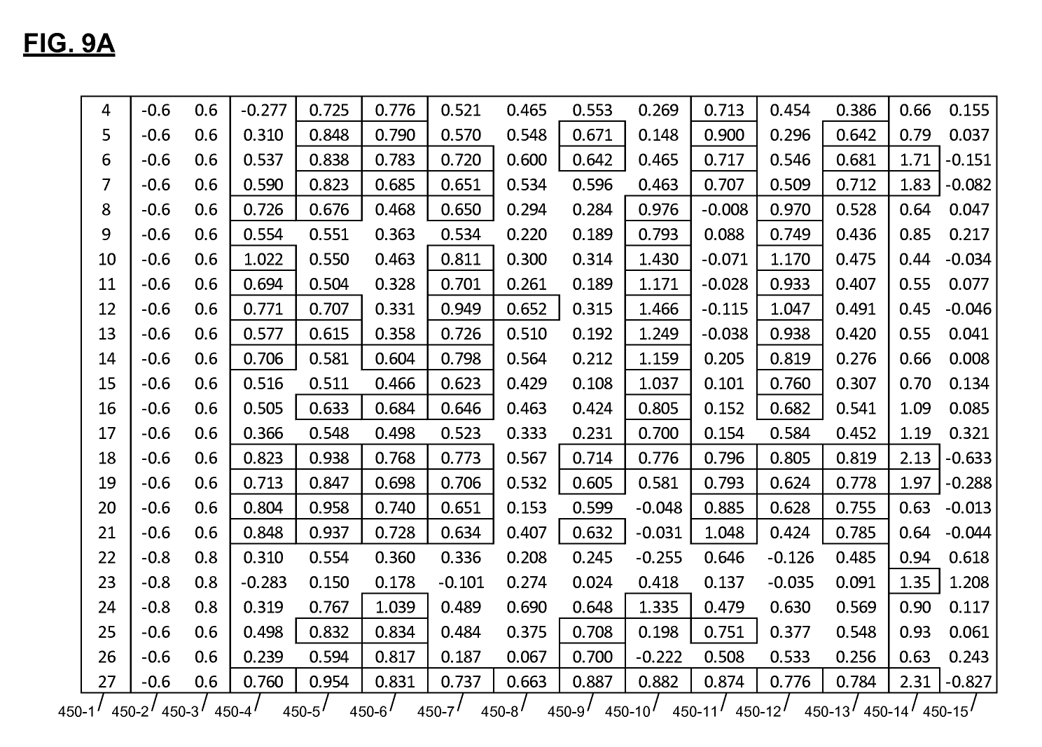

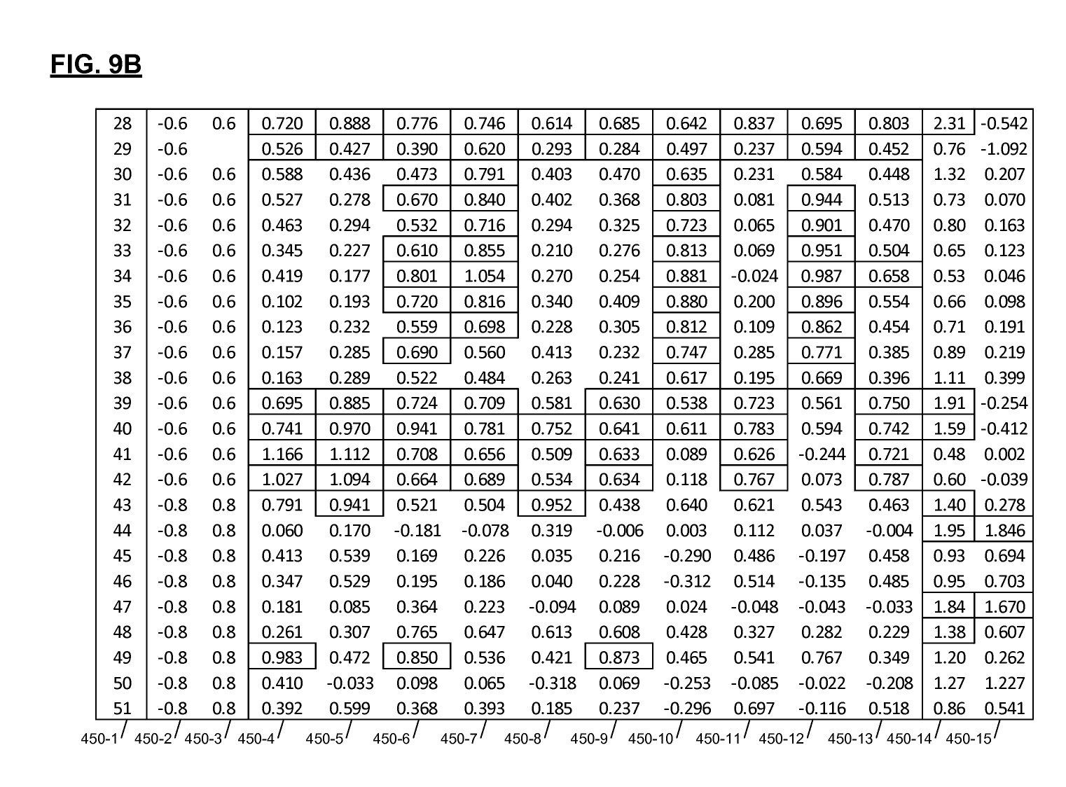

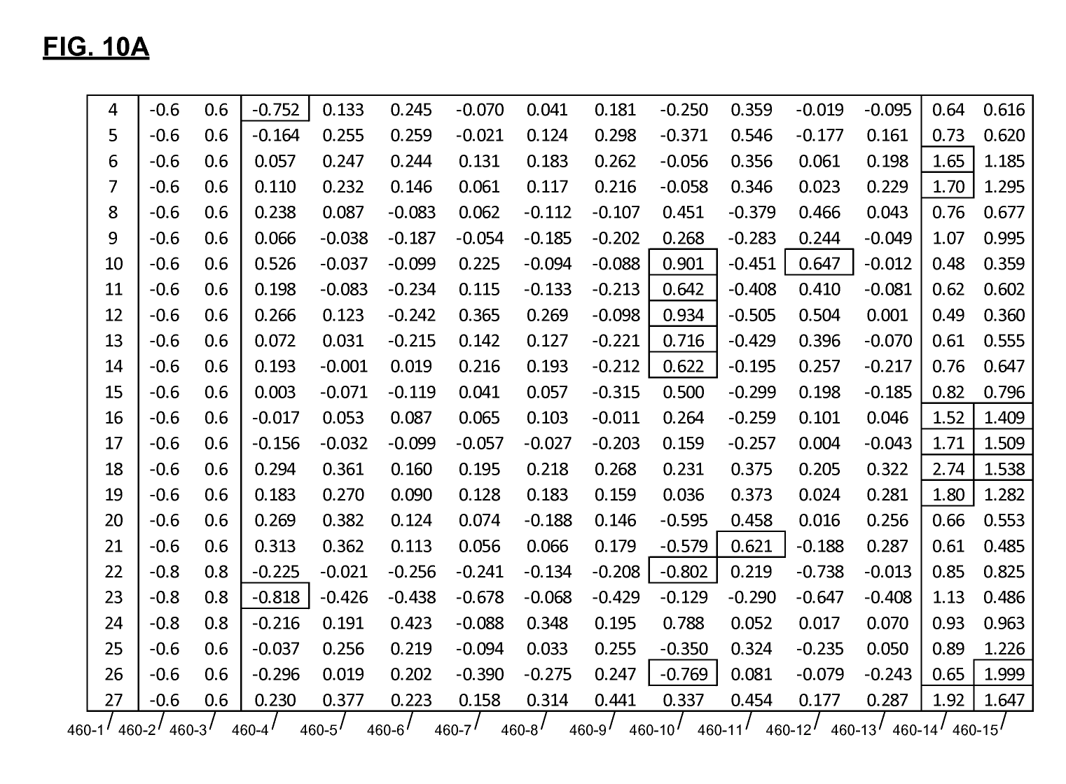

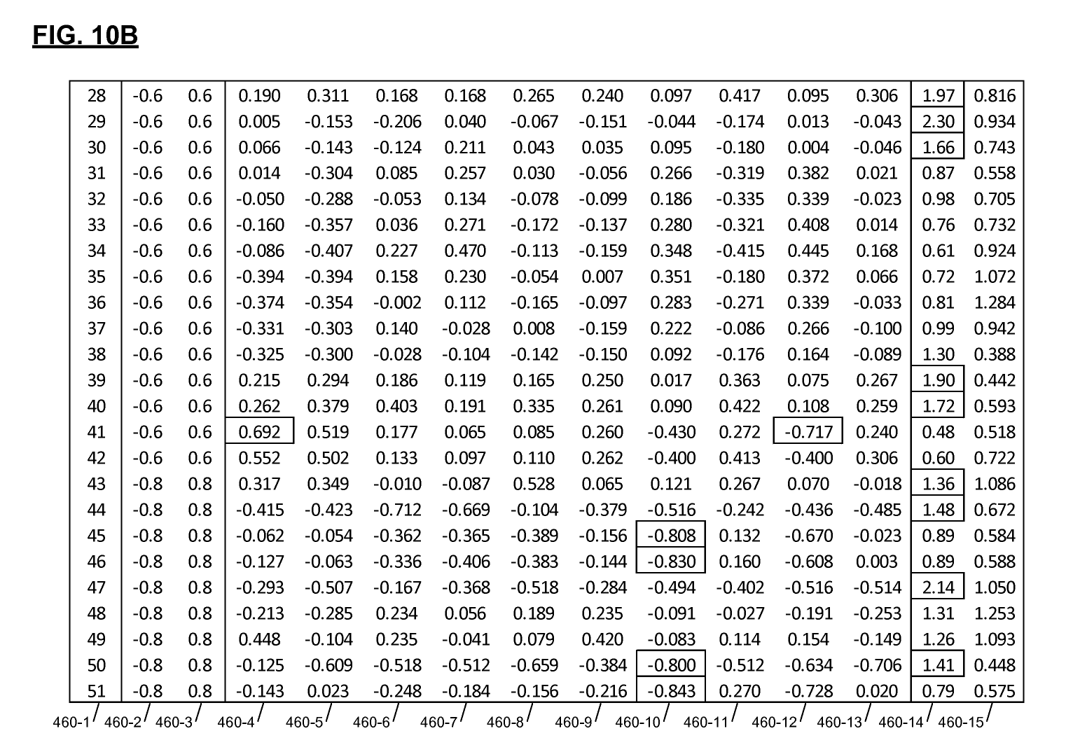

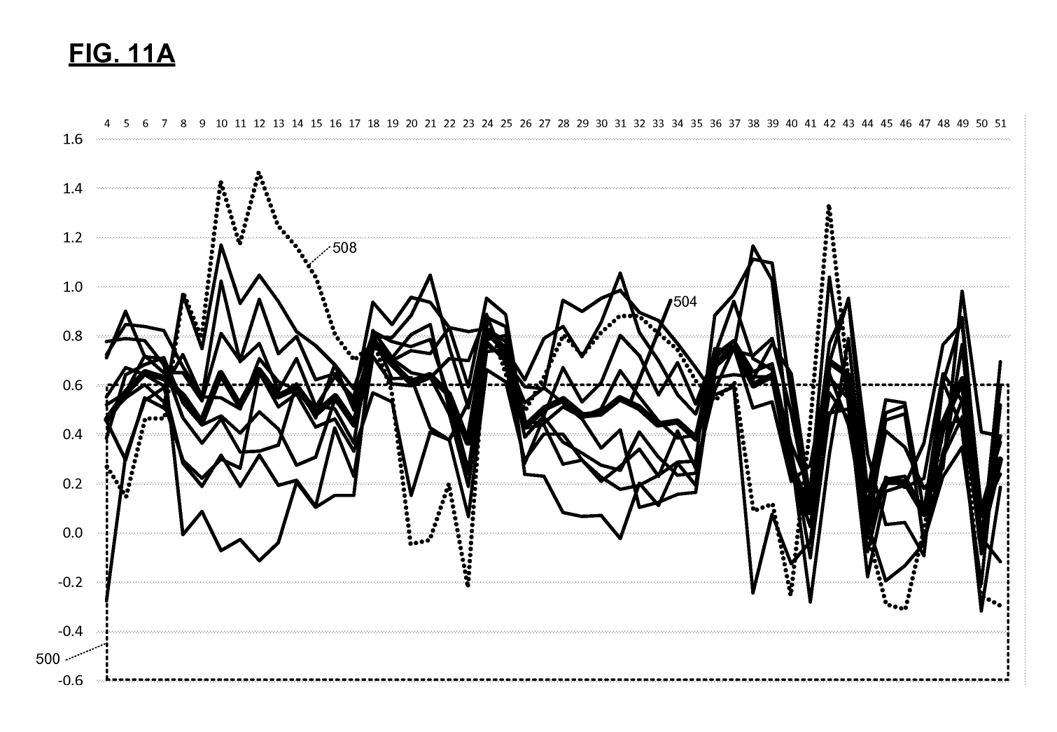

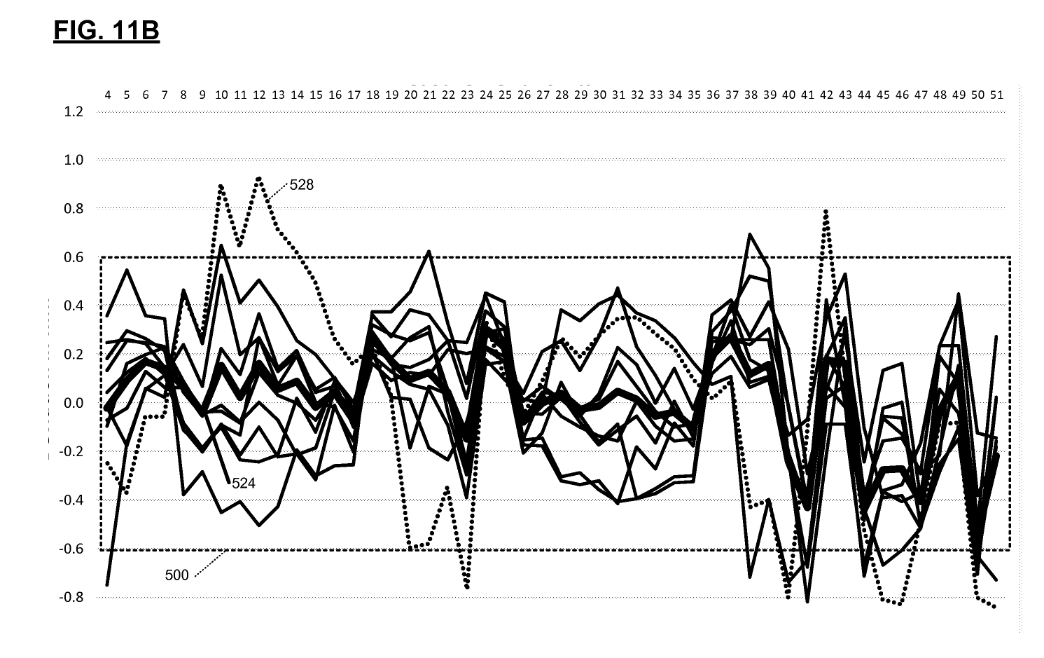

A reporting module 240 reports error data and process capability data to a user and may include graphical matrices of individual parts and measured points as shown in FIGS. 9A-10B, and plots of deviations as shown in FIGS. 11A and 11B. Reports may take various forms and may be transmitted to various users using electronic communication channels or physical printouts. Based on these reports, the design of the part may be updated to accommodate process limitations that cannot achieve certain limitations of the part. In addition, the manufacturing process may be revised to correct persistent defects in manufactured parts.

Process capability for a given dimension or specification may be determined by calculating the mean value μ of that dimension for manufactured parts and calculating standard deviation a of that value for manufactured parts. The process capability is then the difference between the upper specification limit and lower specification limit divided by the product of six and the standard deviation σ:

$${C}_{p} = \frac{U S L - L S L}{6 σ}$$

In general, higher process capability numbers are better.

This process capability may overestimate the capability of the process if the mean μ of the process is not halfway between the upper and lower specification limits. To account for deviations in the mean of the process towards either the upper or lower specification limits, a process capability index is defined as the minimum between an upper process capability and a lower process capability:

$${C}_{p , lower} = \frac{μ - L S L}{3 σ}$$

$${C}_{p , upper} = \frac{U S L - μ}{3 σ}$$

$${C}_{p k} = min [ {C}_{p , lower} , {C}_{p , upper} ]$$

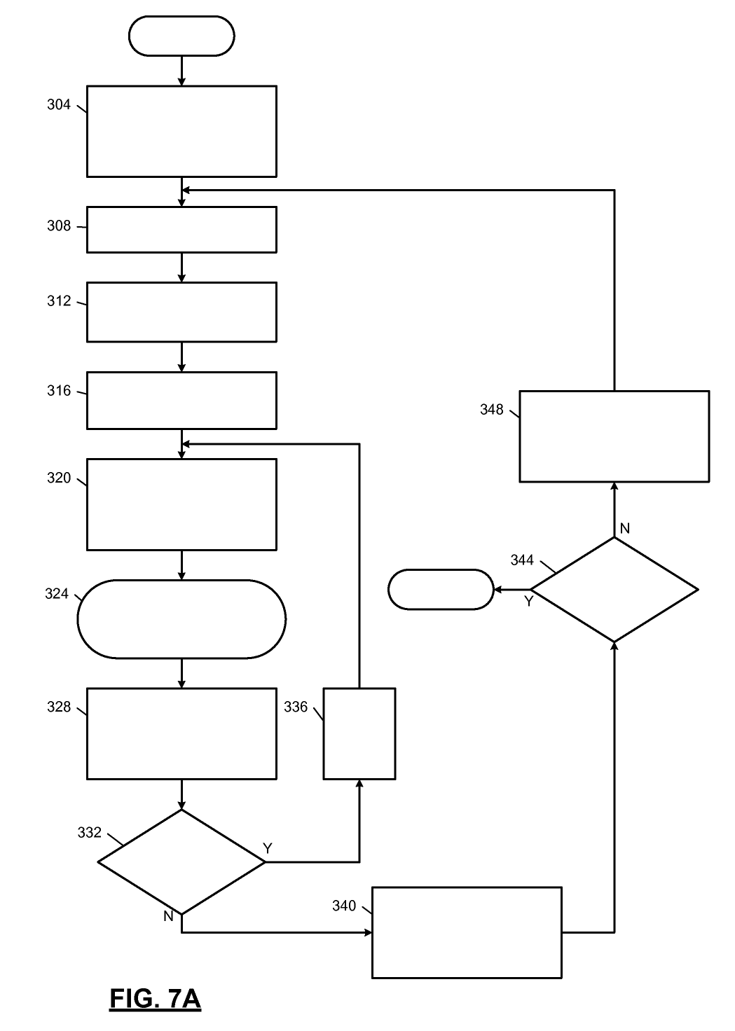

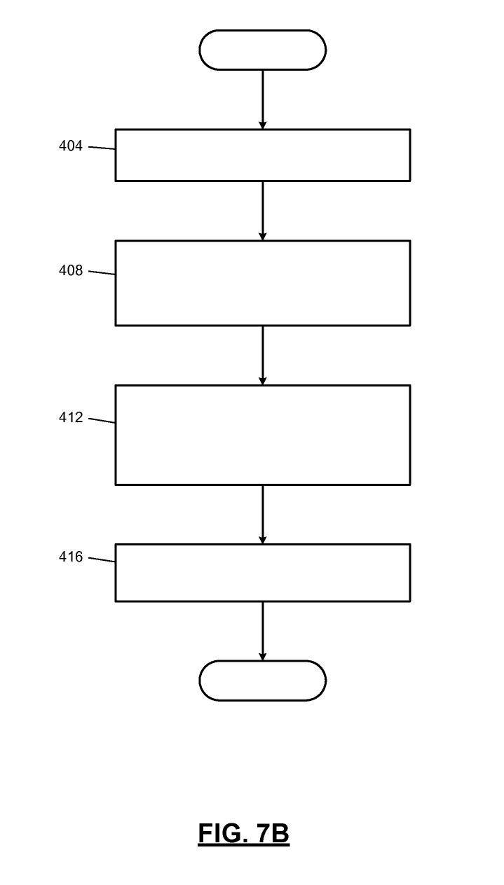

In FIG. 7A, an example design and manufacturing process is shown. Control begins at 304 where a part is designed or the design parameters of a previously-designed part are imported. As part of designing the part, measurement points, tolerances, and desired process capabilities are specified. At 308, parts are manufactured using a chosen process. At 312, a centroid of the designed part is determined.

At 316, a first of the manufactured parts is selected. At 320, the selected part is placed in a fixture where measurement points of the selected part are measured. At 324, control transforms the measurement points on the selected part, such as is shown in more detail in FIG. 7B. At 328, control determines manufacturing deviations for the selected part as transformed. At 332, if there are additional parts from the manufacturing run, control transfers to 336; otherwise, control transfers to 340. At 336, the next part is selected and control returns to 320.

At 340, statistical analysis is performed on the manufacturing deviations transformed at 328. At 344, control determines whether the statistical results meet the design constraints. For example, these constraints may be that each of the measurement points has a process capability of a predetermined threshold. If the constraints are met, control ends; otherwise, control transfers to 348. At 348, one or more of the manufacturing process, the design, the tolerances, or the desired process capabilities are adjusted. Control then returns to 308.

In FIG. 7B, an example transformation is shown. Control begins at 404 where the centroid of the selected part is determined. At 408, control translates measurement points of the selected part based on the difference between the centroid of the selected part and the centroid of the design for the part. At 412, control determines a rotation that minimizes the sum of the squares of deviations between the measurement points of the design and transformed measurement points of the selected part. At 416, control applies the determined rotation 91 transformation to the measurement points of the selected part, and control returns to FIG. 6A.

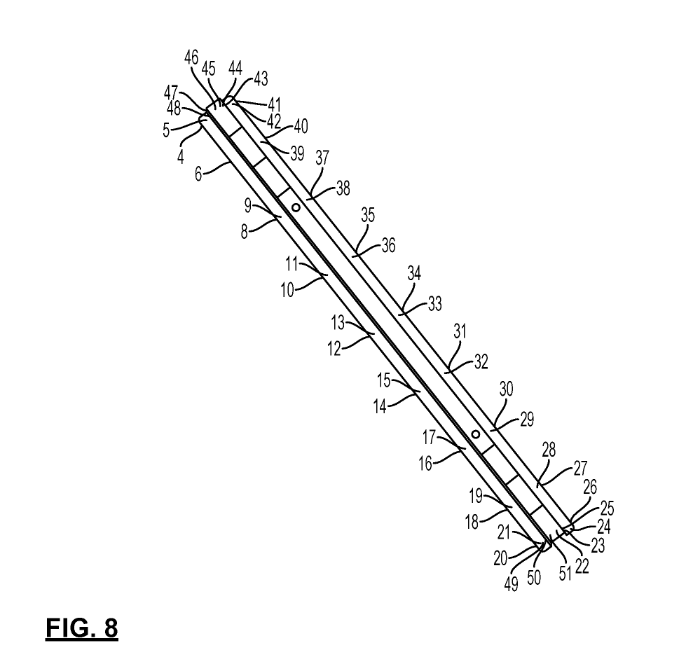

In the following figures, an example part has been designed and manufactured to illustrate some of the potential advantages of the present disclosure. In FIG. 8, a top view of the manufactured part is shown with measurement points labeled. In the example, the measurement points are defined in the z direction, where the x and y axes are in the plane of the drawing and the z axis is extending perpendicular to the plane of the drawing.

In FIGS. 9A-9B, a chart of measurement points is shown where each row corresponds to a different measurement point. The measurement points have not yet been transformed according to the disclosure. There are ten manufactured parts shown as examples, each part corresponding to a respective column 450-4, 450-5, 450-6, 450-7, 450-8, 450-9, 450-10, 450-11, 450-12, and 450-13.

Column 450-1 indicates the measurement point number. The rows are split across two sheets, with the first half of the rows shown in FIG. 9A and the second half shown in FIG. 9B. The actual measured deviation for each point is shown at each intersection of a point and a part. For example only, point 4 of part 1 has a deviation of −0.277 millimeters.

A low tolerance column, 450-2 corresponds to a difference between the design value for the point and a lower specification limit for the point. A high tolerance column 450-3 corresponds to a difference between an upper specification limit for the point and the design value for the point. Therefore, the low and high tolerances fall on either side of zero. Measured points for which the measured deviation of the part exceeds a specified tolerance are identified with an encircling box. For example, point 8 of part 1 (column 450-4) exceeds the 0.6 tolerance and therefore is surrounded by a border.

A process capability (“Cp”) column 450-14 and a process capability index (“Cpk”) column 450-15 indicate the process capability and process capability index for each of the measurement points prior to transformation. Note that while points 27 and 28 both have a relatively high process capability of 2.31, the process capability index for each of these points is actually negative because the mean value of these points is outside of the tolerances.

As seen in FIGS. 9A-9B, many points of a majority of the parts appear to exceed the specification value. In addition, points 27 and 28 exceed the specification tolerances of every single manufactured part, and the measured values for point 40 exceed the tolerance values for all but one of the parts.

Compare FIGS. 9A-9B to FIGS. 10A-10B, where the same parts with the same measurements have been transformed according to the present disclosure. The columns in FIGS. 10A-10B (460-1 through 460-15) correspond to the columns in FIGS. 9A-9B, with deviation numbers for each of the 10 parts (columns 460-4, 460-5, 460-6, 460-7, 460-8, 460-9, 460-10, 460-11, 460-12, and 460-13) after performing the transformation. The process capability column 460-14 and process capability index column 460-15 are each updated based on the revised deviation numbers.

As evident from a visual inspection of FIGS. 10A-10B, the number of points that exceed the defined tolerances is significantly lower than in FIGS. 9A-9B. In fact, aside from part 7, which may have experienced some manufacturing anomaly, there are only six points that exceed the specified tolerances. Further, there are only two points, point 38 and point 10, for which more than one part shows a deviation outside of the specified tolerances.

The attention of the part designer and the process designer can then be focused on a smaller number of points that fall below, for example, a process capability of 1.33. When looking at FIGS. 9A-9B without the transformation, it is difficult to determine where to direct part and manufacturing process design effort. The process capability and process capability index of FIGS. 10A-10B are no longer datum dependent, and can therefore be used across a wider range of measurement devices, operators, and manufacturing processes. The variance due to datum selection may be eliminated or reduced by the present disclosure, revealing true process variance.

In FIG. 11A, a graphical depiction of deviation for each of the parts is shown. In this case, a plot of deviation (in millimeters) on the y-axis for each measurement point on the x-axis is shown for each of the ten parts. Note that the mean of the deviations is high, and therefore, many of the parts fall outside of a tolerance zone 500 from −0.6 to 0.6. A thick line for average deviation is shown and labeled as 504. In addition, the deviation for part 7 across the measurement points is labeled as 508.

Meanwhile, in FIG. 11B, the transformed deviations are plotted. They are now seen to be centered about zero, and many of the points fall within the tolerance zone 500. A thick line for average deviation is shown and labeled as 524. In addition, the deviation for part 7 across the measurement points is labeled as 528.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A OR B OR C), using a non-exclusive logical OR, and should not be construed to mean “at least one of A, at least one of B, and at least one of C.” It should be understood that one or more steps within a method may be executed in different order (or concurrently) without altering the principles of the present disclosure.

In this application, including the definitions below, the term ‘module’ or the term ‘controller’ may be replaced with the term ‘circuit.’ The term ‘module’ may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium include nonvolatile memory circuits (such as a flash memory circuit or a mask read-only memory circuit), volatile memory circuits (such as a static random access memory circuit and a dynamic random access memory circuit), and secondary storage, such as magnetic storage (such as magnetic tape or hard disk drive) and optical storage.

The apparatuses and methods described in this application may be partially or fully implemented by a special purpose computer created by configuring a general purpose computer to execute one or more particular functions embodied in computer programs. The computer programs include processor-executable instructions that are stored on at least one non-transitory, tangible computer-readable medium. The computer programs may also include or rely on stored data. The computer programs may include a basic input/output system (BIOS) that interacts with hardware of the special purpose computer, device drivers that interact with particular devices of the special purpose computer, one or more operating systems, user applications, background services and applications, etc.

The computer programs may include: (i) assembly code; (ii) object code generated from source code by a compiler; (iii) source code for execution by an interpreter; (iv) source code for compilation and execution by a just-in-time compiler, (v) descriptive text for parsing, such as HTML (hypertext markup language) or XML (extensible markup language), etc. As examples only, source code may be written in C, C++, C#, Objective-C, Haskell, Go, SQL, Lisp, Java®, ASP, Perl, Javascript®, HTML5, Ada, ASP (active server pages), Perl, Scala, Erlang, Ruby, Flash®, Visual Basic®, Lua, or Python®.

None of the elements recited in the claims is intended to be a means-plus-function element within the meaning of 35 U.S.C. §112(f), unless an element is expressly recited using the phrase “means for”, or in the case of a method claim using the phrases “operation for” or “step for”.

What is claimed is:

1. A method comprising:
receiving a plurality of values corresponding to measurement points of a first part manufactured according to a first design using a first manufacturing process, wherein the first design specifies design values for the measurement points;
calculating a reference point of the first part based on the received values;
translating the received values based on a difference between the reference point of the first part and a reference point of the first design;
applying a rotational transformation to the translated values to produce transformed values, wherein the rotational transformation includes a first angle;
determining a first value for the first angle that minimizes deviations between the transformed values and the specified design values;
computing deviations between (i) the transformed values corresponding to the first value and (ii) the specified design values;
calculating a process metric of the first manufacturing process based on the computed deviations for the first part and computed deviations for a plurality of additional parts; and
based on the process metric, selectively performing at least one of (i) adjusting the first manufacturing process and (ii) selecting a different process for manufacturing the first design.

2. The method of claim 1, wherein the process metric is one of a process capability and a process capability index.

3. The method of claim 1, wherein:
the plurality of values includes, for each point of the measurement points, a set of coordinates for the point; and
translating the received values includes:
determining translation coordinates by subtracting coordinates of the reference point of the first design from coordinates of the reference point of the first part; and
for each point of the measurement points, generating the translated values by subtracting the translation coordinates from the set of coordinates for the point.

4. The method of claim 1, wherein:
the plurality of values includes, for each point of the measurement points, a set of coordinates for the point; and
coordinates for the reference point of the first design are zero;
translating the received values includes, for each point of the measurement points, generating the translated values by subtracting coordinates of the reference point of the first part from the set of coordinates for the point; and
the applying the rotational transformation rotates the translated values about a zero point.

5. The method of claim 1, wherein:
the reference point of the first design is a centroid of the first design; and
the reference point of the first part is a centroid of the first part.

6. The method of claim 5, further comprising calculating the reference point of the first design, wherein the reference point of the first design is a centroid of the first design.

7. The method of claim 1, wherein the determining the first value includes minimizing an error metric based on a sum of a square of each individual deviation between each of the transformed values and the respective specified design values.

8. The method of claim 1, further comprising measuring the values corresponding to the measurement points of the first part.

9. The method of claim 1, further comprising manufacturing the first part using the first manufacturing process.

10. The method of claim 1, wherein the process metric of the first manufacturing process is calculated based on the computed deviations for the first part and computed deviations for a plurality of additional parts.

11. The method of claim 1, further comprising comparing the first manufacturing process to a second manufacturing process based on the process metric and a process metric of the second manufacturing process.

12. The method of claim 1, further comprising determining a plurality of process metrics, including the process metric, wherein each of the plurality of process metrics corresponds to a respective one of the measurement points of the first design.

13. The method of claim 1, further comprising, in response to the process metric, at least one of (i) modifying the first design and (ii) modifying tolerances of one or more of the measurement points of the first design.

14. The method of claim 1, wherein:
the rotational transformation includes a second angle and a third angle; and
the rotational transformation comprises:
rotating by the first angle about a z-axis of a first coordinate system of the first part, resulting in a second coordinate system;
rotating by the second about a x-axis of the second coordinate system, resulting in a third coordinate system; and
rotating by the third angle about a z-axis of the third coordinate system.

15. A non-transitory computer-readable medium storing instructions executable on a processor, the instructions configured to perform:
receiving a plurality of values corresponding to measurement points of a first part manufactured according to a first design using a first manufacturing process, wherein the first design specifies design values for the measurement points;
calculating a reference point of the first part based on the received values;
translating the received values based on a difference between the reference point of the first part and a reference point of the first design;
applying a rotational transformation to the translated values to produce transformed values, wherein the rotational transformation includes a first angle;
determining a first value for the first angle that minimizes deviations between the transformed values and the specified design values;
computing deviations between (i) the transformed values corresponding to the first value and (ii) the specified design values;
calculating a process metric of the first manufacturing process based on the computed deviations for the first part and computed deviations for a plurality of additional parts; and
based on the process metric, selectively performing at least one of (i) adjusting the first manufacturing process and (ii) selecting a different process for manufacturing the first design.

16. A measurement system comprising:
a design input module configured to receive design values specifying a plurality of measurement points of a first design;
a measurement input module configured to receive a plurality of values corresponding to measurement points of a first part manufactured according to the first design using a first manufacturing process;
a reference determination module configured to calculate a reference point of the first part based on the received values;
a translation module configured to translate the received values based on a difference between the reference point of the first part and a reference point of the first design;
a rotation module configured to apply a rotational transformation to the translated values to produce transformed values, wherein the rotational transformation includes a first angle;
an error minimization module configured to determine a first value for the first angle that minimizes deviations between the transformed values and the specified design values;
an error determination module configured to compute deviations between (i) the transformed values corresponding to the first value and (ii) the specified design values;
an analysis module configured to calculate a process metric of the first manufacturing process based on the computed deviations for the first part and computed deviations for a plurality of additional parts; and
a reporting module configured to report the process metric.

17. The measurement system of claim 16, wherein the process metric is one of a process capability and a process capability index.

18. The measurement system of claim 16, wherein:
the reference point of the first design is a centroid of the first design;
the reference point of the first part is a centroid of the first part;
coordinates for the reference point of the first design are zero;
the plurality of values includes, for each point of the measurement points, a set of coordinates for the point; and
translating the received values includes, for each point of the measurement points, generating the translated values by subtracting coordinates of the reference point of the first part from the set of coordinates for the point; and
the applying the rotational transformation rotates the translated values about a zero point.

19. The measurement system of claim 16, wherein the design input module is configured to calculate the reference point of the first design and translate the specified design values of the first design to locate the reference point of the first design at a zero point of a coordinate system.

20. The measurement system of claim 16, wherein the determining the first value includes minimizing an error metric based on a sum of a square of each individual deviation between each of the transformed values and the respective specified design values.
